(19) United States
(12) Patent Application Publication
(10) Pub. No.: US 2007/0204509 A1
(43) Pub. Date: Sep. 6, 2007

(54) Root irrigator

(76) Inventors: Osman Lotero, Wellington, FL (US); Jonathan W. Bachmann, Coral Springs, FL (US)

Correspondence Address: ROBERT M. DOWNEY, P.A., 6751 N. FEDERAL HWY., SUITE 300, BOCA RATON, FL, 33487, US

(21) Appl. No.: 11/370,146

(22) Filed: Mar. 6, 2006

(51) Int. Cl. A01G 29/00

(52) U.S. Cl. 47/48.5

(57) ABSTRACT

A tool for eliminating air pockets in the soil when planting trees and shrubs has an inverted L-shaped rigid tubular body with an elongate vertical extension terminating at an open distal end and a horizontal section terminating at an open proximal end. A fluid passage extends between the open proximal end and the open distal end. The open proximal end is provided with internal threads for attachment of a conventional garden hose in order to direct a pressurized stream of water through the tool and out from the bottom distal end. A lever-actuated valve on the horizontal section is operable between an open position to permit water discharge from the distal end, and a closed position to interrupt discharge of water from the distal end of the tool. A driving handle is selectively attachable to either one of a pair of angled attachment stubs on the vertical extension to accommodate both left handed and right handed users. A second hand grip portion is provided on the horizontal section, near the lever-actuated valve.

### BACKGROUND OF THE INVENTION

1. Field of the Invention

This invention relates generally to an apparatus for injecting water below the ground surface, and more particularly to a tool for delivering a pressurized flow of water to the root base of plants, shrubs and trees in order to eliminate air pockets that are created when filling in soil to surround the root base during the planting process.

2. Description of the Related Art

When planting a tree, shrub or other plant, it is first necessary to dig a sufficiently sized hole to receive the root ball of the plant. Once the plant is properly positioned in the ground, the soil removed when digging the hole is replaced and filled in around the root ball in the hole. This process inevitably results in the formation of air pockets or voids at areas around the root ball which, if not eliminated, will cause the roots of the plant to dry from exposure to air and lack of water and nutrients. Eventually, if the air pockets remain, the exposed roots will die and the plant will suffer from lack of nourishment. Over time, the growth of the plant will be stunted and, in some instances, the plant will not survive.

Accordingly, there remains an urgent need in the nursery and landscape industry for a simple, low cost tool which effectively removes air pockets surrounding the root ball when planting trees, shrubs and other plants.

### SUMMARY OF THE INVENTION

The present invention is directed to a tool for delivering water to the root base of trees and shrubs in order to eliminate air pockets when planting the trees and shrubs in the ground. The tool is defined primarily by an inverted L-shaped rigid tubular body which has an elongate vertical extension terminating at an open distal end and a horizontal section terminating at an open proximal end. A fluid passage extends between the open proximal end and the open distal end for directing a pressurized flow of water therethrough and out from the distal end. Internal threads at the proximal end allow for attachment of a conventional garden hose. A lever-actuated valve on the horizontal section is operable between an open position to permit water discharge from the distal end, and a closed position to interrupt discharge of water from the distal end of the tool. A driving handle is selectively attachable to either one of a pair of angled attachment stubs on the vertical extension to accommodate both left handed and right handed users. A second hand grip portion is provided on the horizontal section, near the lever-actuated valve.

### BRIEF DESCRIPTION OF THE DRAWINGS

For a fuller understanding of the nature of the present invention, reference should be made to the following detailed description, taken in connection with the accompanying drawings in which:

FIG. 1 is a side elevational view, in partial cut-away, showing the root irrigating tool of the present invention;

FIG. 2 is a top plan view of the root irrigating tool;

FIG. 3 is a front elevational view of the tool;

FIG. 4 is an isolated bottom plan view taken along the line 4-4 in FIG. 3; and

FIG. 5 is an isolated view showing the lower and of the tool driven into the soil adjacent to a root system of a newly planted tree, illustrating operation of the tool.

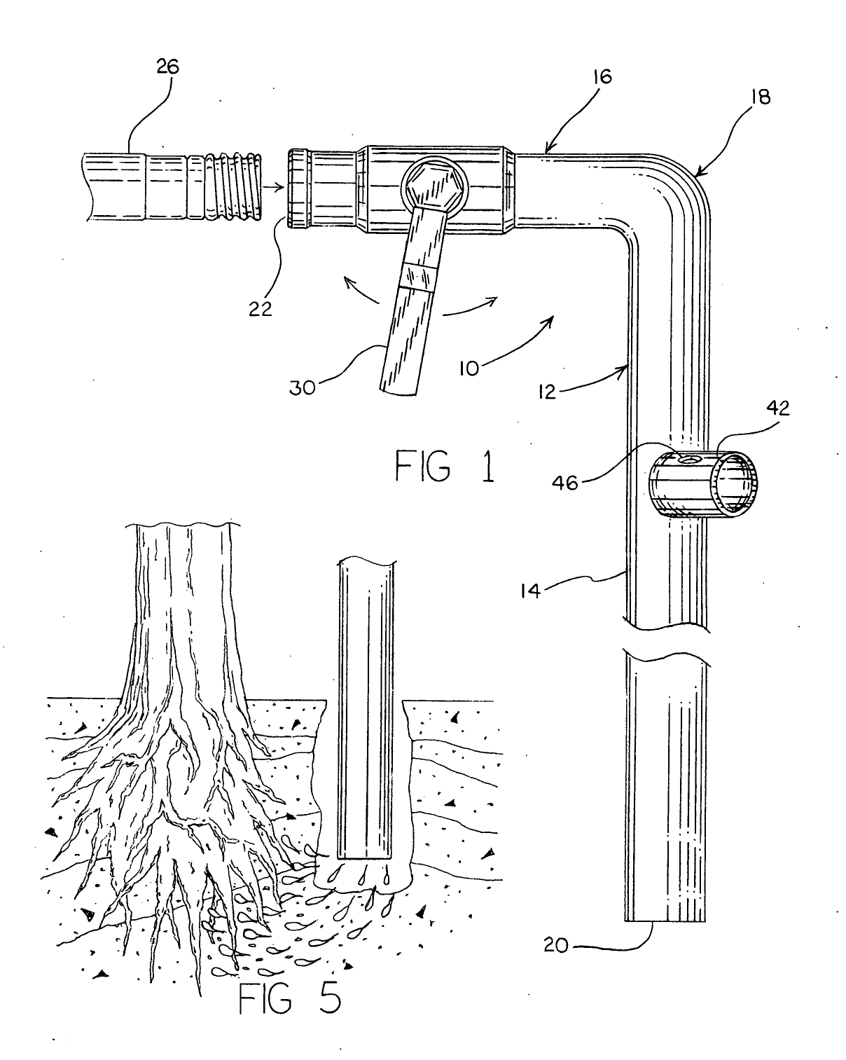

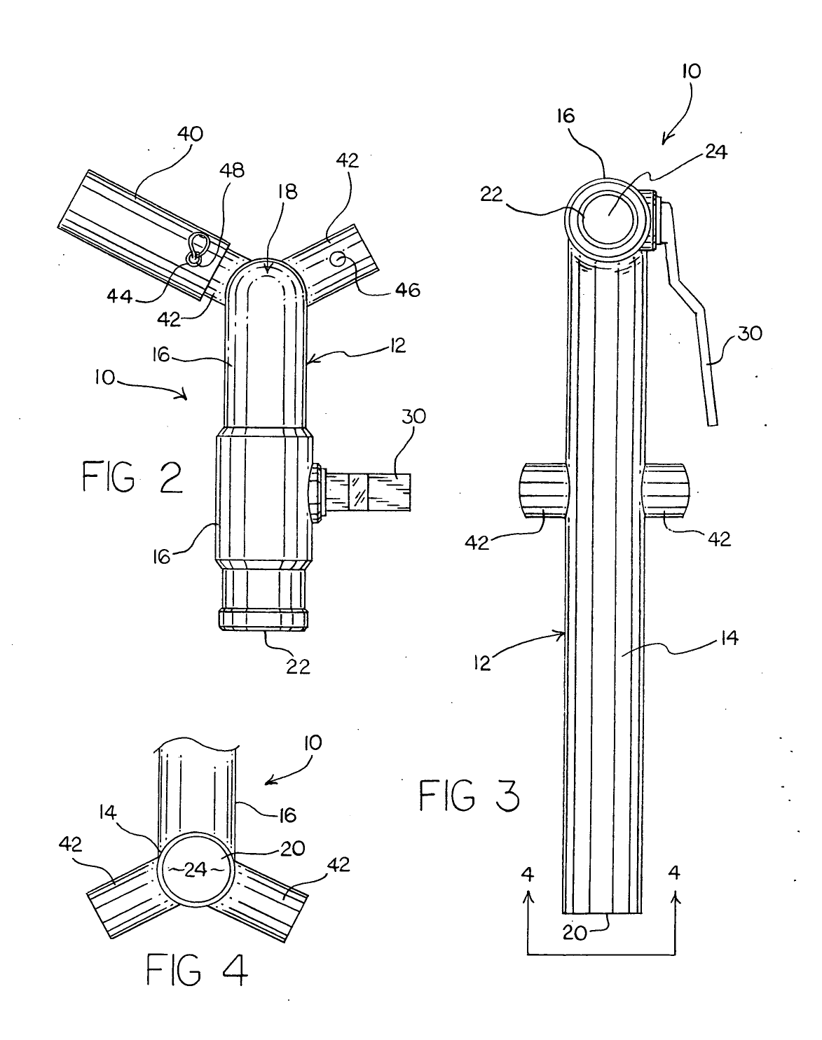

Like reference numerals refer to like parts throughout the several views of the drawings.

### Detailed Description of the Preferred Embodiment

Referring to the several drawing figures, the root irrigator tool of the present invention is shown and is generally indicated 10. The tool 10 has a main body 12 which is L-shaped, including an elongate vertical extension 14, a horizontally extending section 16, and an elbow 18 between the vertical extension and horizontal section.

The elongate vertical extension 14 extends downwardly from the elbow 18 and terminates at an open distal end 20. The horizontal section 16 extends from the elbow 18, generally perpendicular to the vertical extension 14, and terminates at an open proximal end 22. A fluid passage 24 extends through the entire tool from the open proximal end 22 to the open distal end 20. The open proximal end 22 is provided with internal threads for attachment of a conventional garden hose 26 thereto. Accordingly, pressurized flow of water from the garden hose 26 is directed through the fluid passage 24 and outwardly from the bottom distal end 20.

A lever 30 operates a valve device within the horizontal section 16 to selectively interrupt discharge of water from the bottom distal end 20 until the tool 10 is positioned in the ground and ready for use. In a preferred embodiment, the valve mechanism is a ball valve and is operable, using the lever 30, between a closed position to interrupt discharge of water from the distal end 20, and an open position to permit water flow through the fluid passage and out from the distal end 20.

In a preferred embodiment, the vertical extension 14 measures at least 3 feet in length from the elbow 18 to the bottom distal end 20. In use, the bottom distal end 20 is forced down through the loose soil filled around the root ball of the newly planted tree, shrub or other plant. In most instances, the vertical extension is driven down into the soil approximately 6 to 18 inches, depending upon the size of the root ball of the plant and the depth of the hole within which the root ball is planted. Once the bottom distal end 20 is driven down into the soil and positioned next to or just below the root ball, the lever 30 is operated from the closed position to the open position, thereby allowing the pressurized flow of water to be released from the distal end 20. This agitates the loose soil and removes air pockets. The soil, now in a more dense mud form, settles towards the bottom of the hole, below and around the root ball of the plant. This operation of driving the distal end 20 into the loose soil and operating the lever to discharge water is repeated numerous times around the base of the plant as soil is continually filled in the hole surrounding the root ball.

To facilitate driving the distal end 20 down into the soil, a driving handle 40 is provided on the vertical extension 14. In a preferred embodiment, the driving handle 40 is removably attachable to either of two angled stub members 42 fixed to the side of the vertical extension. This allows for selective positioning of the driving handle 40 to accommodate both left handed and right handed users. In a preferred embodiment, the driving handle 40 is hollow and slips onto either of the stub members 42. Through holes 44, 46 on the driving handle 40 and the stub members 42, respectively, align when the driving handle 40 is properly positioned on the stub. A locking pin 48 is then inserted through the aligned holes 44, 46 to secure the driving handle to the respective stub member 42. A second hand grip may be provided on the horizontal section 16. By grasping both the driving handle 40 on the vertical extension 14 and the second hand grip on the horizontal section 16, the tool can be easily driven into the soil and removed as soil is filled around the root ball of the plant.

While the instant invention has been shown and described in accordance with a preferred and practical embodiment thereof, it is recognized that departures from the instant disclosure are contemplated within the spirit and scope of the invention.

What is claim is:

1. A garden tool comprising:
a main body with a rigid elongate vertical extension terminating at an open distal end, and said main body further including an open proximal end;
a fluid passage between said open proximal end and said open distal end;
said proximal end being structured for removable attachment of a water supply hose thereto in order to receive a pressurized flow of water through said open proximal end and through said fluid passage for discharge out from said open distal end;
a valve on said main body operable between an open position to permit water discharge from said open distal end, and a closed position to interrupt the discharge of water from the open distal end; and
at least one handle extending generally perpendicular to said elongate vertical extension for grasping with at least one hand to drivingly force said open distal end down into soil adjacent to a root system of a plant, wherein pressurized discharge of water from said open distal end agitates the soil surrounding the root system to eliminate air pockets while simultaneously supplying water to the root system of the plant.

2. The garden tool as recited in claim 1 wherein said main body includes a horizontal extension and an elbow between said horizontal extension and said vertical extension.

3. The garden tool as recited in claim 2 wherein said valve is fitted to said horizontal extension and within said fluid passage.

4. The garden tool as recited in claim 3 wherein said horizontal extension is rigid.

5. The garden tool as recited in claim 1 further comprising:
a lever attached to said valve for operating said valve between said open position and said closed position.

6. The garden tool as recited in claim 1 wherein said at least one handle is removably attachable to said main body.

7. The garden tool as recited in claim 1 further comprising:
a plurality of handles extending from said vertical extension for grasping and drivingly forcing the open distal end down into the soil adjacent to the root system of the plant.

8. The garden tool as recited in claim 1 wherein said valve is a ball valve.
